(19) United States
(12) Patent Application Publication
(10) Pub. No.: US 2016/0104184 A1
(43) Pub. Date: Apr. 14, 2016

(54) RULES GALLERY FOR INCENTIVES PROGRAM

(71) Applicant: ThinkSmart Solutions, Inc., San Francisco, CA (US)

(72) Inventors: Miguel Yacobi, Tiburon, CA (US); Alfonso Garcia, Tiburon, CA (US); Manuel Chilla, Madrid (ES)

(21) Appl. No.: 14/882,162

(22) Filed: Oct. 13, 2015

Related U.S. Application Data
(60) Provisional application No. 62/063,310, filed on Oct. 13, 2014.

(51) Int. Cl. G06Q 30/02; G06Q 10/06

(52) U.S. Cl. CPC G06Q 30/0214; G06Q 10/06398

(57) ABSTRACT

An incentives platform receives information about business processes from a plurality of businesses. The information includes specific performance information for employees of each of the businesses. Each business may use the platform to tailor an incentives program for its employees, where employees receive rewards based on their performance metrics. The platform includes a gallery of predefined rules for computing the incentives, allowing a business to select one or more incentives from the gallery.

### CROSS-REFERENCE TO RELATED APPLICATIONS

This application claims the benefit of U.S. Provisional Application No. 62/063,310, filed Oct. 13, 2014, which is incorporated by reference in its entirety.

### BACKGROUND

This invention relates generally to incentive programs for a business, and more specifically to generating an incentive program for a business.

Many businesses implement incentive programs to motivate their employees to perform certain actions. For example, a business provides an employee with additional compensation for selling greater than a specified number of products within a specified time interval. As another example, a business ranks employees based on number of products sold or amount of revenue generated and provides additional benefits (e.g., additional compensation, additional vacation time) to employees having at least a threshold position in the ranking.

Conventionally, different businesses internally develop incentive programs or collaborate with external vendors that design incentive programs. Frequently, businesses or vendors designing incentive programs rarely measure the return on investment of an incentive program, and often rely on personal preferences or loose interpretation of prior results when developing incentive programs. Accordingly, effectiveness of incentive programs is rarely evaluated by a third party or accessible to other entities.

### SUMMARY

To allow a business to more easily implement an incentive program, the rule system maintains information describing rules for providing employees with benefits based on satisfying performance metric criteria identified by the rules. In addition to storing the rules, the rule system includes additional information associated with various rules. For example, the rule system associates information with each rule in a set describing a number of times a rule has been implemented by one or more businesses, describing ratings or comments received from various businesses and associated with a rule, describing operation of a rule, describing strengths and weaknesses of a rule, or identifying additional rules as alternatives to a rules. The rule system may receive information from businesses describing performance of rules selected from the rule system by the businesses. For example, information describing effects of a rule on a budget of a business (e.g., compensation provided by the business to employees based on the rule) is received from the business and associated with the rule by the rule system. The rule system receives information describing rules from businesses over time, allowing the rule system to maintain accurate information describing performance of various rules.

The rule system may also evaluate employees of a business based on one or more rules associated with the business and stored by the rule system 140. For example, the business authorizes the rule system to access a subset if information associated with employees of the business and maintained by the business. Information accessible to the rule system does not include information allowing the rule system to determine identities of the business's employees, but allows the rule system to determine whether an employee of the business satisfies performance metric criteria specified by a rule. Based on the accessed subset of information, the rule system determines if information associated with various employees satisfy performance metric criteria specified by various rules applicable to the employees. If information associated with an employee satisfies performance metric criteria of a rule, the rule system communicates information describing a benefit associated with the rule to the business, allowing the business to accordingly compensate the employee.

The rule system obtains information associated with a business and suggests or recommends one or more rules to the business based on the obtained information. For example, based on an industry associated with a business, the rule system recommends one or more rules previously implemented by at least a threshold number of additional businesses associated with the same industry to the business or previously implemented at least a threshold number of times by businesses associated with the same industry. Additionally, prior performance of various rules may be used by the rule store to recommend rules. For example, rules having at least at threshold performance are recommended. As another example, the rule system identifies an industry associated with the business and identifies one or more rules implemented by at least a threshold number of additional businesses associated with the industry to the business. In another example, the rule system obtains budget information for the business, such as a budget or budget range, and selects one or more rules having previously provided amounts of compensation that do not exceed the budget or that are within the budget range. Rules identified by the rule system may have been created by businesses different than the business or may have been created by the business itself. Hence, the rule system allows a user authorized with a business to view information describing rules stored by the rule system, which may be created or provide by other businesses, and identify rules for implementation by the business form the information describing the rules stored by the rule system.

### BRIEF DESCRIPTION OF THE DRAWINGS

FIG. 1 is a block diagram of a system environment for a rule system, in accordance with an embodiment of the invention.

FIG. 2 is an example interface provided by the rule system that identifies various rules maintained by the rule system, in accordance with an embodiment of the invention.

FIG. 3 is an example rule creation interface provided to an authorized user of a business by a rule system, in accordance with an embodiment of the invention.

FIG. 4 is an example interface for selecting a category including a rule provided by the rule system, in accordance with an embodiment of the invention.

FIG. 5 is an example interface for selecting an incentive campaign provided by the rule system in accordance with an embodiment of the invention.

FIG. 6 is an example of an interface prompting an authorized user of a business to identify a name, description, and a duration associated with the rule, in accordance with an embodiment of the invention.

FIG. 7 is an example interface for an authorized user of a business to identify employees of the business to whom a rule is applied, in accordance with an embodiment of the invention.

FIG. 8 is an example interface for identifying employees to exclude from application of rules, in accordance with an embodiment of the invention.

FIG. 9 is an example interface for an authorized user of a business to provide information identifying additional employees of the business to whom the rule is applied, in accordance with an embodiment of the invention.

FIGS. 10-13 are example interfaces for specifying criteria associated with a rule to a rule system, in accordance with an embodiment of the invention.

FIG. 14 is an example summary interface describing information about a rule provided to the rule system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

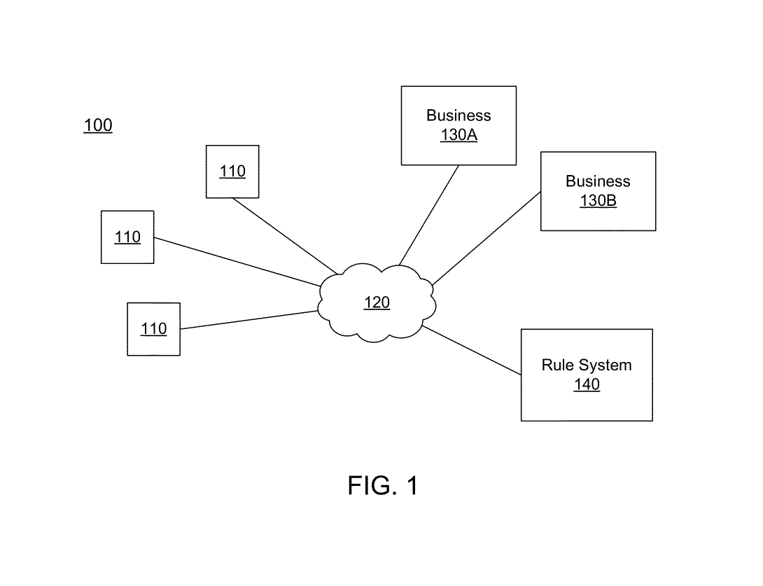

FIG. 1 is a block diagram of a system environment 100 for a rule system 140. The system environment 100 shown by FIG. 1 comprises one or more client devices 110, a network 120, one or more businesses 130A, 130B (also referred to individually and collectively using reference number 130), and the rule system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the rule system 140. For example, a client device 110 executes a browser application to enable interaction between the client device 110 and the rule system 140 via the network 120. In another embodiment, a client device 110 interacts with the rule system 140 through an application programming interface (API) running on a native operating system of the client device 110, such as IOS® or ANDROID™. Client devices 110 may be associated with users who are employees of one or businesses 130 and allow the employees to obtain or communicate data to a business.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more businesses 130A, 130B may be coupled to the network 120 for communicating with the rule system 140. A business 130 is associated with one or more employees who receive compensation from the business for performing various actions. To motivate employees to perform actions, a business 130 may implement an incentive program that provides employees with additional compensation or other benefits based on one or more rules. A rule associates a benefit with one or more performance metrics, so an employee receives the benefit when actions associated with the employee satisfy the one or more performance metrics. Examples of performance metrics include: a total number of sales, an amount of revenue, an amount of revenue generated within a specified time interval, a number of sales of a specific product or service, a threshold rating or evaluation, whether actions associated with an employee meet or exceed a target (e.g., whether a number of sales of a product equals or exceeds a threshold number), a threshold accuracy between actions of a user and predicted actions of the user, a position in a ranking relative to other employees, and a total number of a specific action performed by an employee. Other examples of performance metrics include: employee completion of one or more wellness goals, a number or percentage of wellness activities in which a user participated or completed, a number of percentage of training programs completed by employees, employee participation or completion of training programs in one or more subject areas, customer feedback received for an employee (e.g., a rating of an employee by customers), a number of reviews of an employee received from customers, recognition of an employee, or any other activity of an employee for which information describing the activity may be tracked or maintained. For example, a rule specifies an amount of compensation for an employee providing the business with at least a threshold amount of revenue. As another example, a rule specifies an amount of vacation time an employee receives for having at least a threshold position in a ranking of employees based on performance metrics associated with the employees (e.g., based on number of sales of a product or based on amount of revenue generated). In other examples, a rule specifies a number of points an employee receives for completing a threshold number of training programs; the employee may subsequently exchange the points with one or more entities for goods or services or, in some embodiment, exchange the points for monetary compensation based on the points from a business 130 employing the employee. In some embodiments, the rule system 140, further described below, provides the employee with goods or services in exchange for points; alternatively, the business 130 or a third party system receives points from the employee and provides goods or services to the employee. For example, the business 130, the rule system 140, or other entity maintains a catalog of products or services provided to an employee in exchange for points, such as points received by the employee through a rule. Businesses 130 provide rules to the rule system 140, which stores the rules for subsequent retrieval by the business 130 or by additional businesses 130. In various embodiments, the rule system 140 provides an interface for a business 130 to generate one or more rules stored by the rule system 140.

To allow a business 130 to more easily implement an incentive program, the rule system 140 maintains information describing rules for providing employees with benefits based on satisfying performance metric criteria. In addition to storing the rules, the rule system 140 may include additional information associated with various rules. For example, the rule system 140 associates information with a rule describing a number of times a rule has been implemented by a business 130, describing ratings or comments received from various businesses and associated with a rule, describing operation of a rule, describing strengths and weaknesses of a rule, or identifying additional rules as alternatives to a rules. However, in various embodiments, any suitable information may be associated with a rule. Additionally, the rule system 140 may receive information from businesses 130 describing performance of rules selected from the rule system 140 by the businesses 130. For example, information describing effects of a rule on a budget of a business 130 (e.g., compensation provided by the business 130 to employees based on the rule) is received from the business 130 and associated with the rule by the rule system 140. Information describing rules may be received from businesses 130 over time, allowing the rule system 140 to provide accurate information describing performance of various rules. In some embodiments, the rule system 140 communicates with the business 130 to receive information describing performance of rules stores by the rule system 140 subject to approval or verification from the business. Information the rule system 140 receives does not include information allowing the rule system 140 to determine an identity of an employee of the business 130, but may include data for evaluating employees based on a rule.

The rule system 140 may also evaluate employees of a business 130 based on one or more rules associated with the business 130 and stored by the rule system 140. For example, the business 130 authorizes the rule system 140 to access a subset if information associated with employees of the business 130 and maintained by the business 130. Based on the accessed subset of information, the rule system 140 determines if performance metrics associated with various employees satisfy criteria of various rules applicable to the employees. If an employee's performance metric satisfies criteria of a rule, the rule system 140 communicates information describing a benefit associated with the rule to the business 130, allowing the business 130 to accordingly compensate the employee.

Based on information associated with a business 130 or provided by the business 130, the rule system 140 may suggest or recommend one or more rules to the business 130. For example, based on an industry associated with a business 130, the rule system 140 recommends one or more rules previously selected by at least a threshold number of additional businesses 130 associated with the same industry to the business 130. Additionally, prior performance of various rules may be used by the rule store 140 to recommend rules. For example, rules having at least at threshold performance are recommended. The business 130 may also provide information to the rule system 140 for recommending rules. For example, the business 130 identifies an industry associated with the business 130 and a budget or budget range, and the rule system 140 identifies one or more stored rules based on the industry and budget information. The recommended rules may be rules received by the rule system 140 from additional businesses 130 or created by additional businesses 130 via the rule system 140. In some embodiments, the rule system 140 maintains a catalog of products or services provided to employees of a business 130 in exchange for points provided to the employees. A business 130 may access the catalog through an application programming interface provided to the business 130 by the rule system 140, or through any other suitable method.

Hence, the rule system 140 allows a user authorized with a business 130 to view information describing rules stored by the rule system 140, which may be created or provide by other businesses, and identify rule for implementation by the business form the information describing the rules stored by the rule system 140. The rule system 140 may identify a gallery of candidate rules for a business 130 based on an industry associated with the business 130, a number of employees of the business 130, a budget for a rule specified by the business 130, or other suitable information. Prior performance of rules stored by the rule system 130 may also be used to identify the gallery of candidate rules. For example, rules having at least a threshold rating by other businesses 130 having a threshold number of characteristics matching characteristics of the business 130 are identified as candidate rules. The business 130 may select one or more rules from the gallery of candidate rules to implement an incentive program for its employees.

### Creating Rules

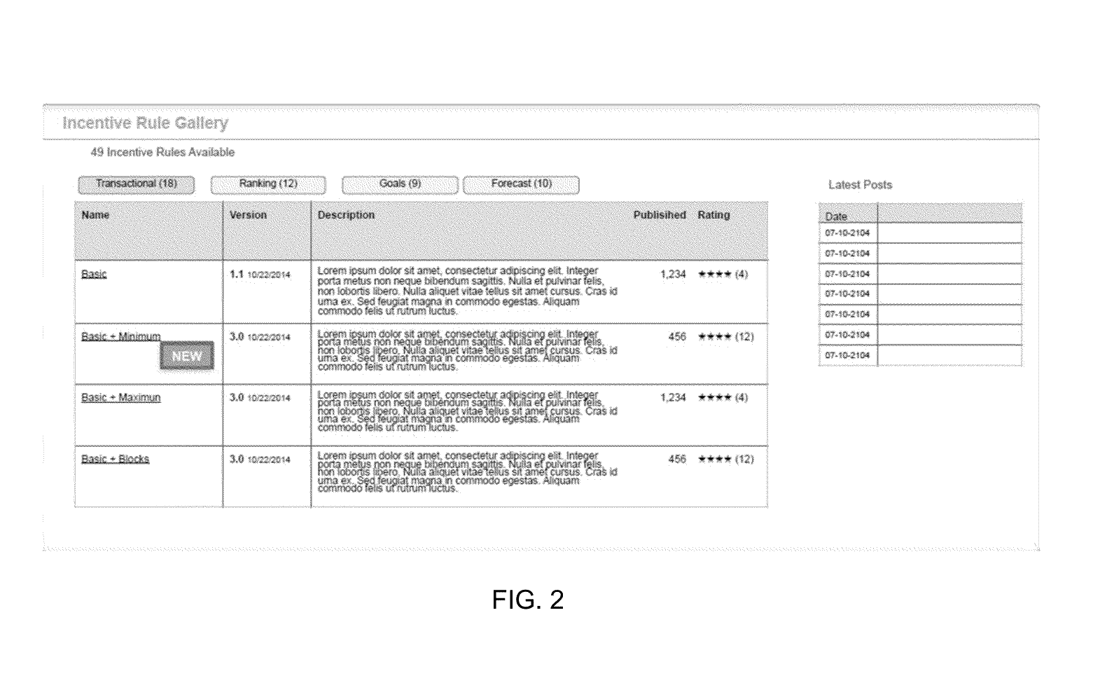

FIG. 2 is an example interface provided by the rule system 140 that identifies various rules maintained by the rule system 140. A business may select one or more rules from the interface of FIG. 2 to obtain information for implanting the selected one or more rules. In the example of FIG. 2, the interface presents a name of a rule, a description of the rule, a rating of the rule by businesses 140 that previously implemented the rule, and a number of times the rule has been retrieved or implemented by businesses. Additionally, information describing a version and a modification date associated with a rule may also be displayed, allowing users from a business 130 to determine how recently the rule has been modified. In some embodiments, an indication that a rule was created or received by the rule system 140 within a threshold time from a current time is presented, allowing a user to identify rules recently received or created.

The rules presented in the interface may be organized based on a type. A type associated with a rule may specify a performance metric used by the rule. Example types include: transactional rules, ranking rules, goal-based rules, and forecast rules. A transactional rule is based on a number of occurrences of an action or a number of products or services sold, while a ranking rule is based on an employee's position in a ranking relative to other employees. A goal-based rule is based on whether an employee's actions equal or exceed a threshold amount of action (e.g., whether the employee sold at least a threshold number of products), and a forecast rule is based on a difference between an employee's actions and actions predicted for the user. Selecting a type causes the interface to present rules having the selected type.

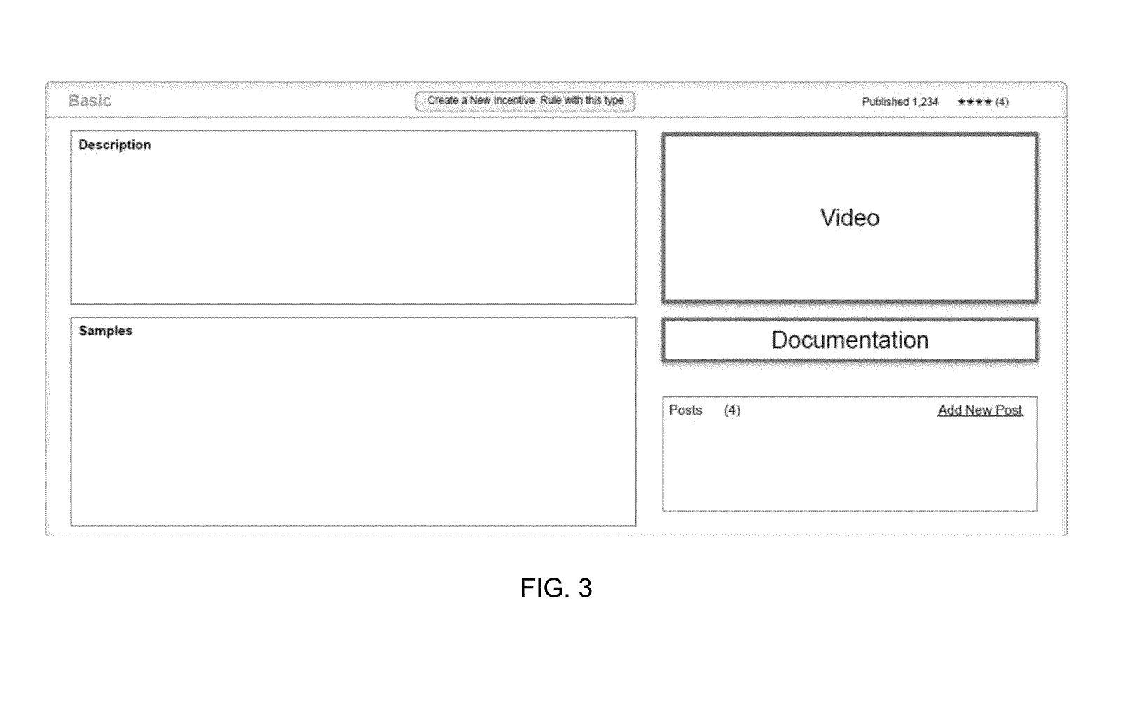

A user associated with a business 130 may create a rule via the rule system 140. In various embodiments, a business 130 identifies one or more authorized users to the rule system 140, allowing the authorized users to create or select rules via the rule system 140 on behalf of the business. If an authorized user requests creation of a rule, the rule system 140 provides the authorized user with a rule creation interface, an example of which is shown in FIG. 3. The rule creation interface includes a field for specifying a description of the rule (i.e., the criteria for a performance metric and a benefit provided if the criteria are satisfied). Additionally, the rule creation interface allows the authorized user to provide documentation describing implementation of the rule, example implementations of the rule. Video data or audio data associated with the rule may also be provided via the rule creation interface. In some embodiments, information describing alternative implementations of the rule, possible modifications to the rule, or other information associated with the rule may also be provided.

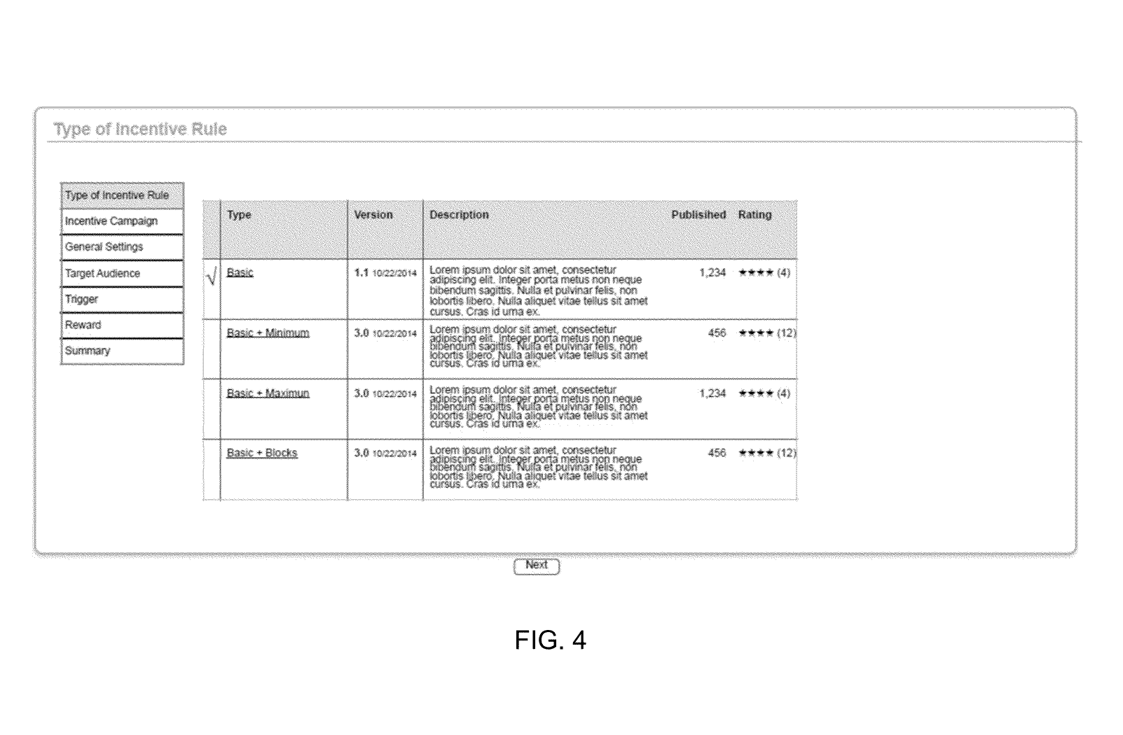

When creating a rule, the authorized user of the business 130 specifies one or more characteristics of the rule. For example, the authorized user of the business 130 specifies if the rule is included in an incentive campaign that also includes additional rules, if the rule applies to a specific set of employees (e.g., employees in a specific location, employees with a specific title, etc.). When creating a rule, the rule system 140 provides the authorized user of the business with an interface, such as the interface shown in FIG. 4, to select a category including the rule. In the example of FIG. 4, the interface shows example categories of rules based on rules maintained by the rule system 140. For example, the interface identifies a category including basic rules (e.g., rules that provide a benefit if a criteria is met), a category including rules specifying a minimum criteria before a benefit is provided, a category including rules specifying a maximum criteria before a benefit is provided or after which a benefit is no longer provided, and rules specifying different benefits. Information describing different categories of rules may also be shown in the interface (e.g., prior performance of rules in a category, ratings of rules in the category received from businesses, a number of times rules in the category have been implemented, etc.). The information presented may be based on information received by the rule system 140 from additional businesses 130, such as additional businesses associated with a common industry as the business 130 or having other characteristics matching or similar to characteristics of the business 130. Further, the information presented may be based at least in part on evaluation of prior performance of rules in various categories by the rule system 140 based on information received from businesses 130 having at least a threshold similarity to the business 130.

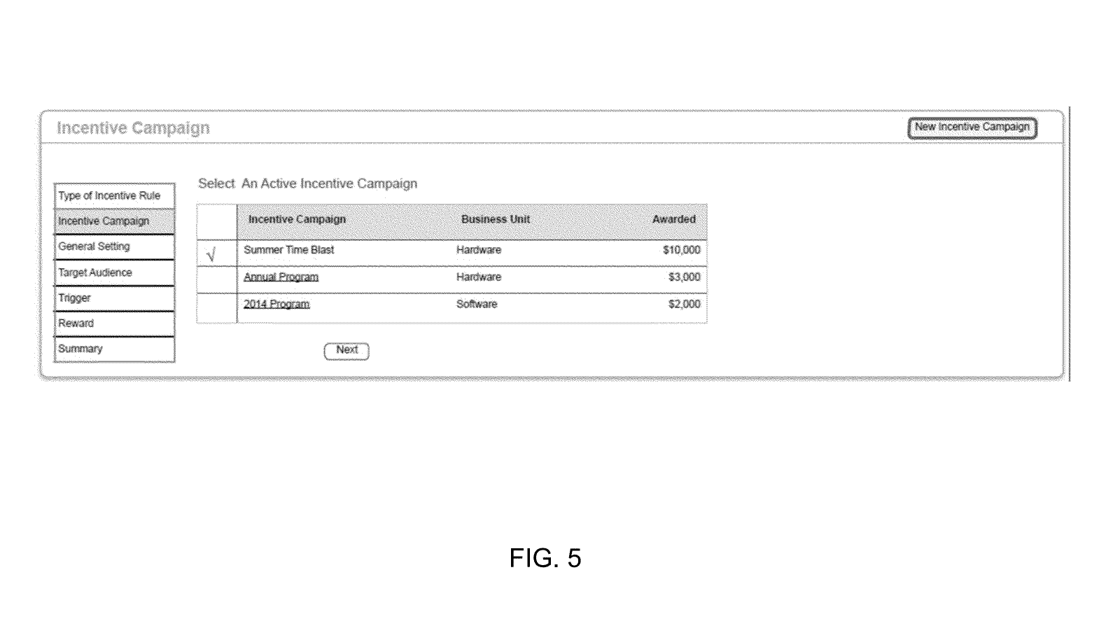

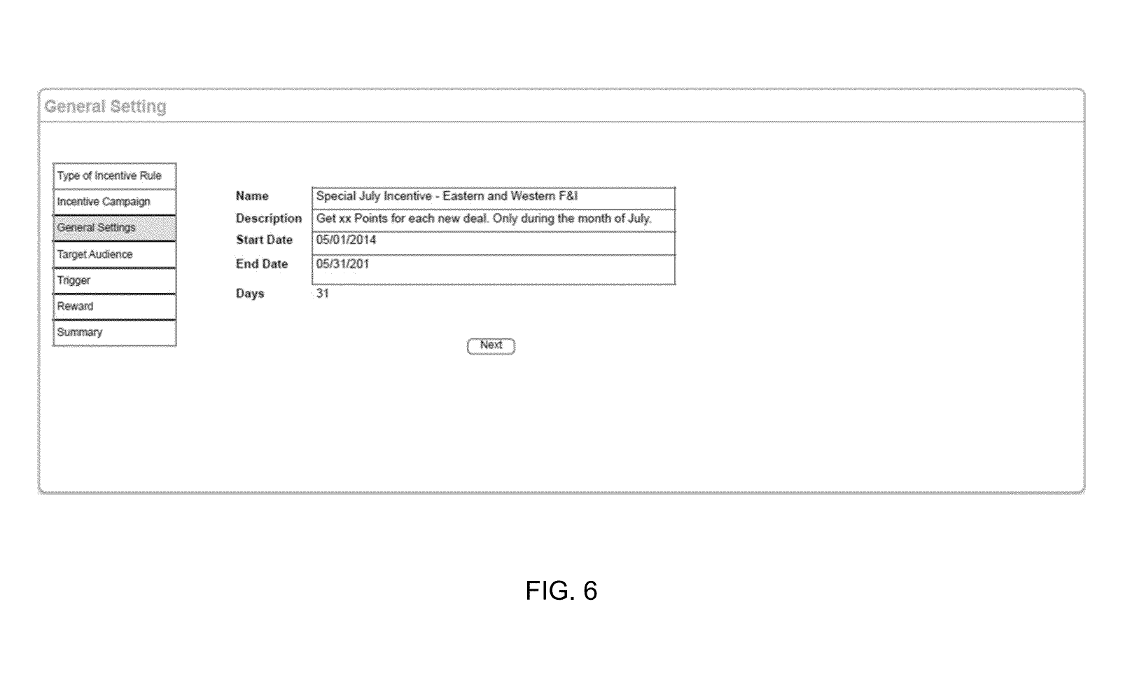

After receiving a selection of a category including the rule, the rule system 140 presents an interface where the authorized user selects an incentive campaign including the rule. FIG. 5 shows an example interface for selecting an incentive campaign where incentive campaigns associated with the business associated with the authorized user are presented, allowing the authorized user of the business 130 to select an incentive campaign including the rule. After selecting an incentive campaign, the authorized user of the business 130 is presented with an interface to provide information describing the rule. In the example interface of FIG. 6, the authorized user of the business is prompted to identify a name, description, and a duration associated with the rule. The name identifies the rule, while the description provides additional information describing implementation of the rule. In FIG. 6, the authorized user of the business identifies a start date and an end date to identify the duration, but the duration may be specified using any suitable format in various embodiments.

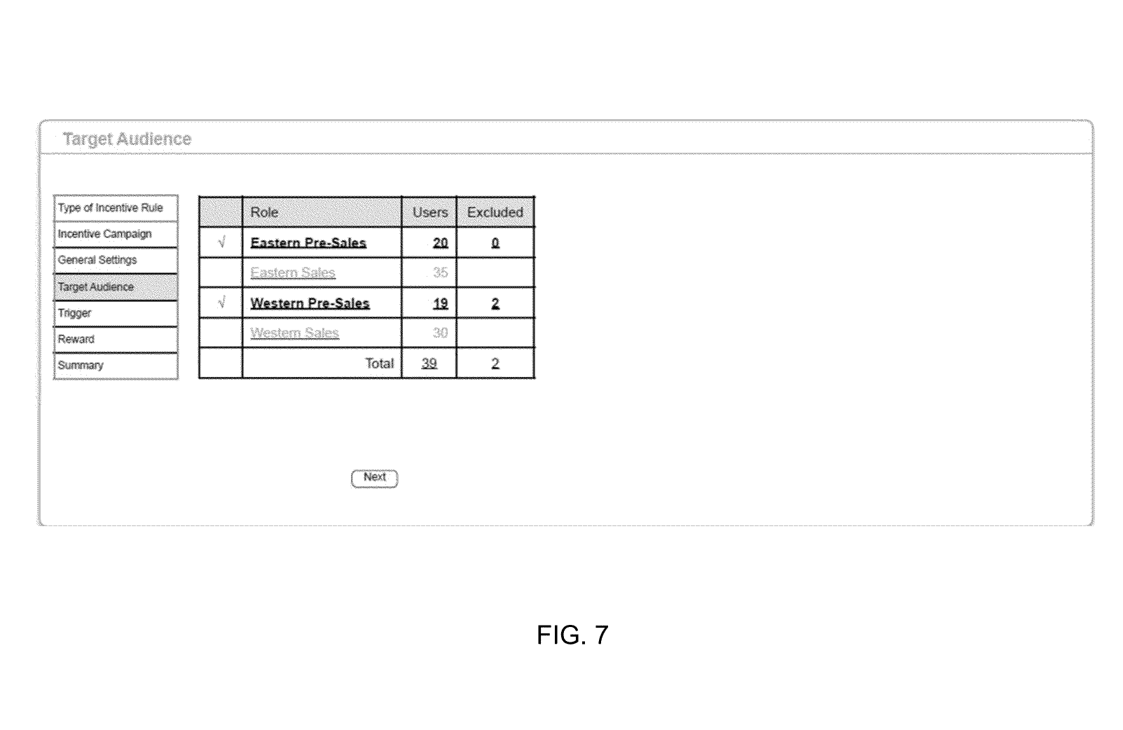

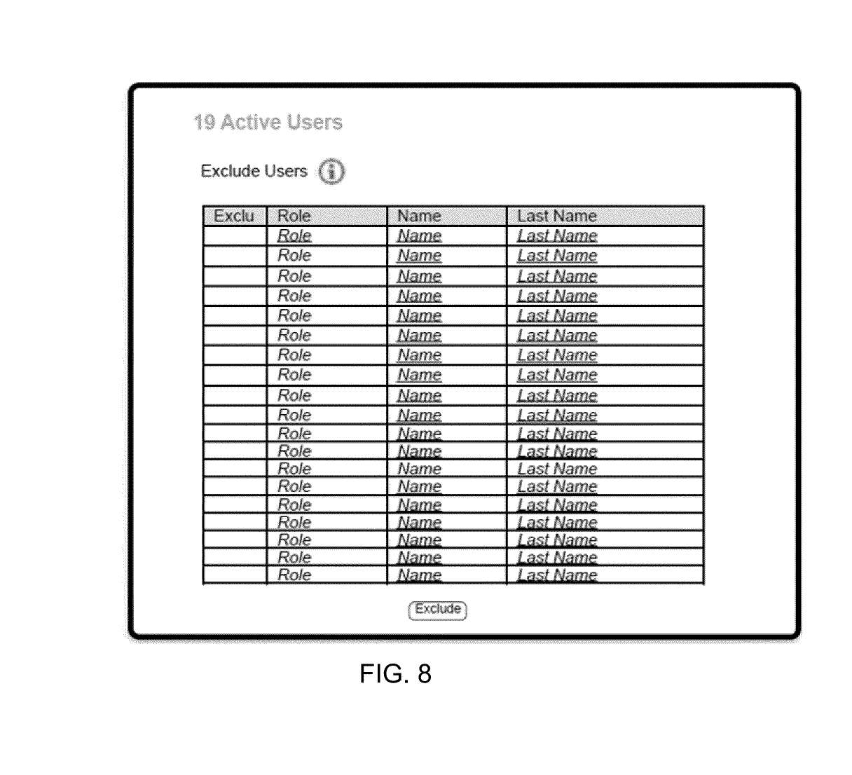

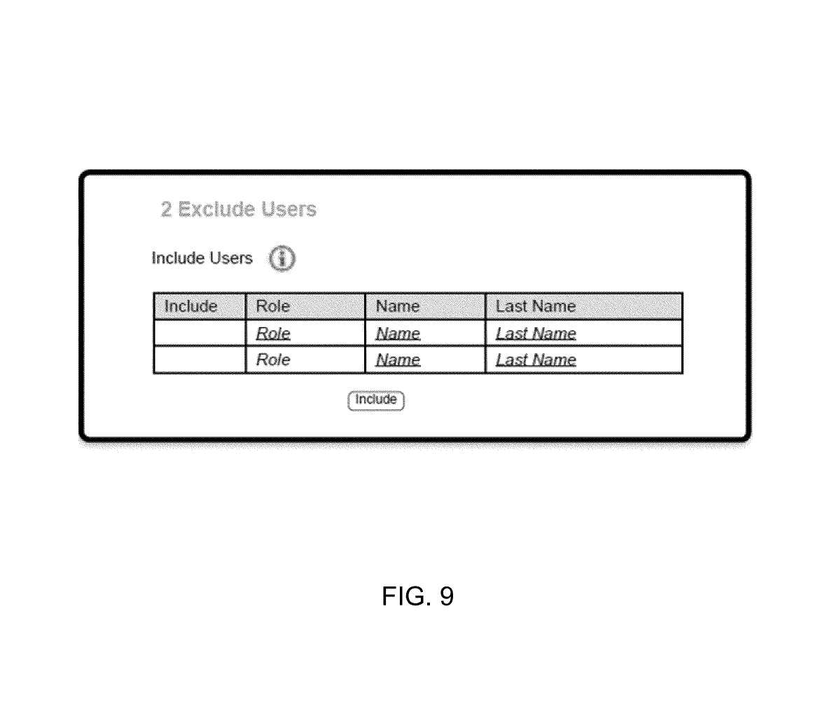

FIG. 7 shows an interface for the authorized user of the business 130 to identify employees of the business to whom the rule is applied. For example, the authorized user identifies employees in specific geographic locations, in specific departments, having a specific job title, having a specific experience level, or any other suitable characteristics for identifying employees. When identifying employees, the authorized user may specifically identify one or more employees to whom the rule is not applied. FIG. 8 shows an example interface for identifying employees to exclude from application of the rules. Specific employees may be excluded from the rule or a group of employees having a specific characteristic may be excluded from the rule. FIG. 9 shows an example interface allowing the authorized user to identify additional employees to whom the rule is applied by providing information identifying the users.

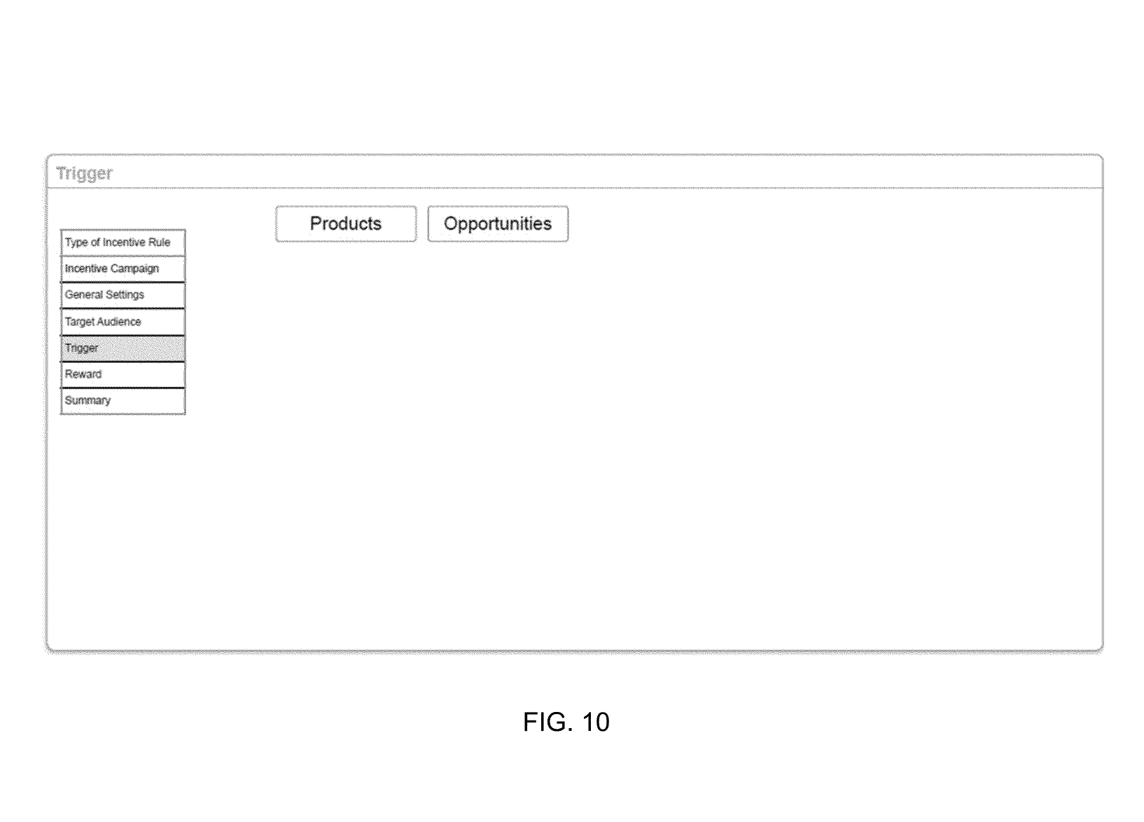

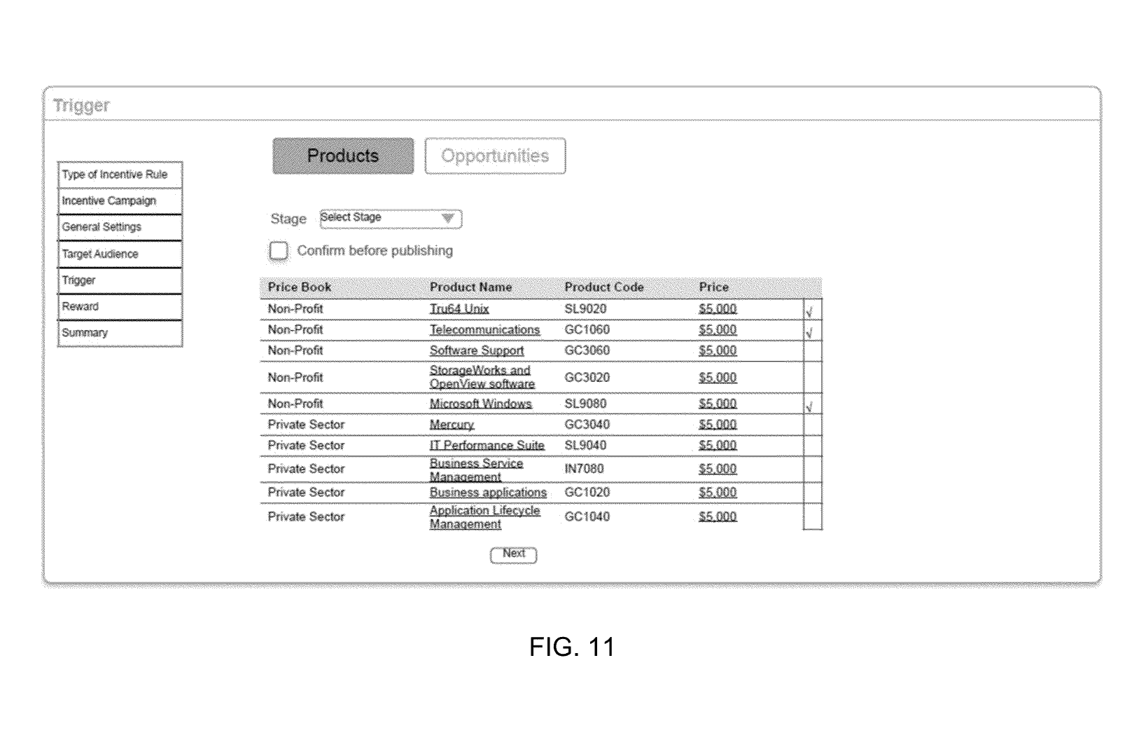

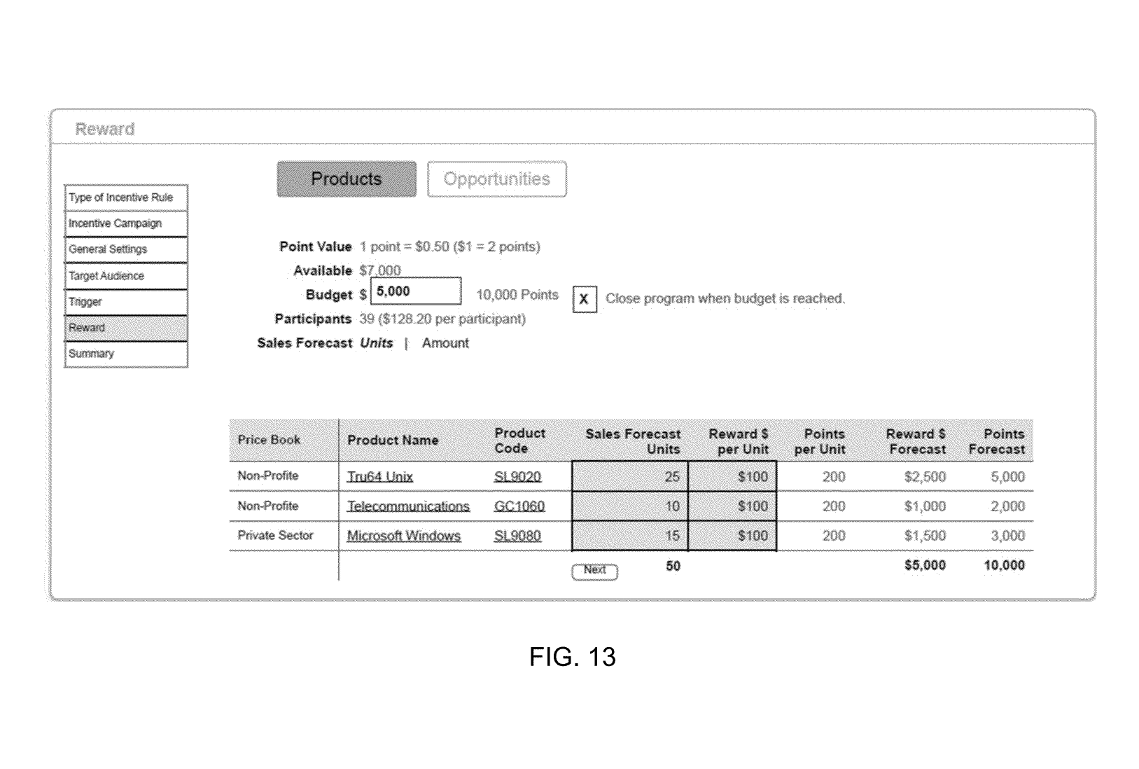

FIGS. 10-13 illustrate interfaces for specifying criteria associated with the rule. The criteria identify one or more performance metrics that when satisfied by an employee, cause the business 130 to provide the employee with a benefit specified by the rule. In the example of FIG. 11, the interface presents products associated with the business, allowing the authorized user of the business to select products for determining performance metrics of users. The rule system 140 may identify or recommend products to use for determining performance metrics based on other rules stored by the rule system 140 (e.g., additional rules associated with the business 130 or associated with other businesses 130 having at least a threshold number of common characteristics with the business 130). FIG. 13 illustrates an example interface allowing the authorized user to specify a budget for the rule. Additionally, the interface of FIG. 13 may also provide information describing an estimated result of the rule based on information associated with the business 130 or with similar businesses 130 having implemented a similar rule. For example, the interface identifies a predicted amount the business 130 will compensate employees based on different products included in the rule, allowing the authorized user to determine a predicted effect of the rule on sales of various products or to determine an expected cost to the business 130 from benefits predicted to be provided to employees.

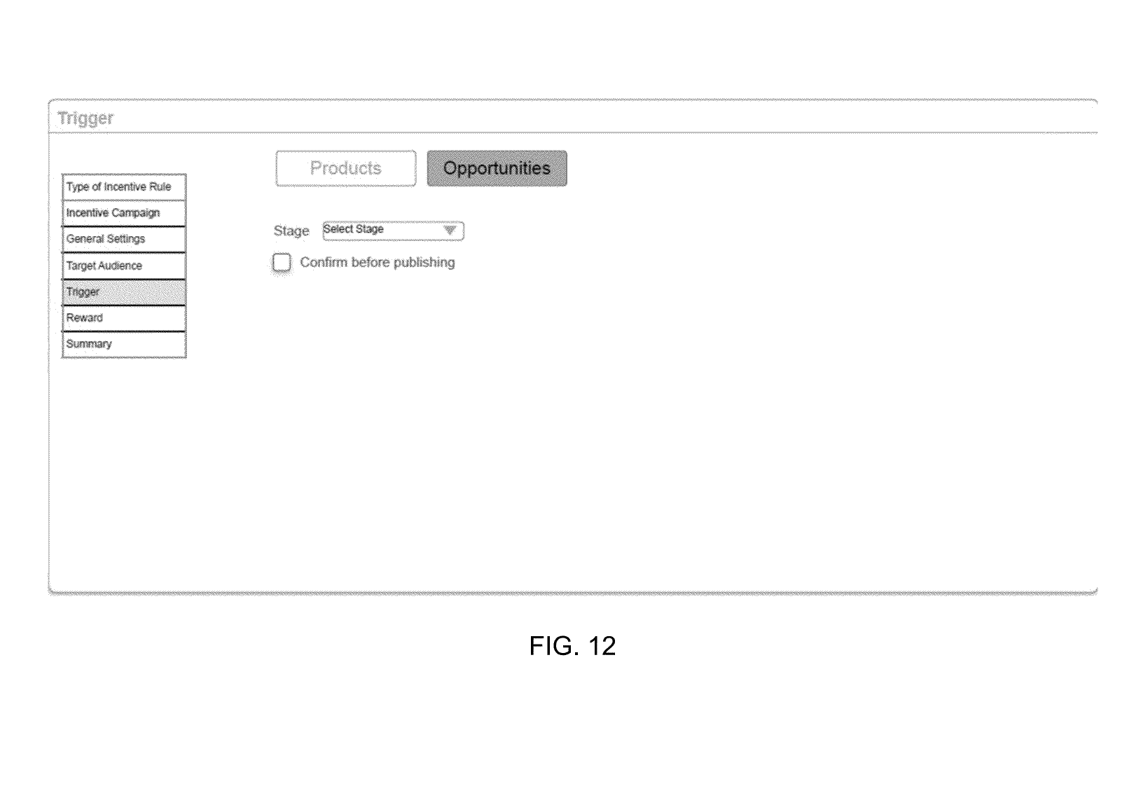

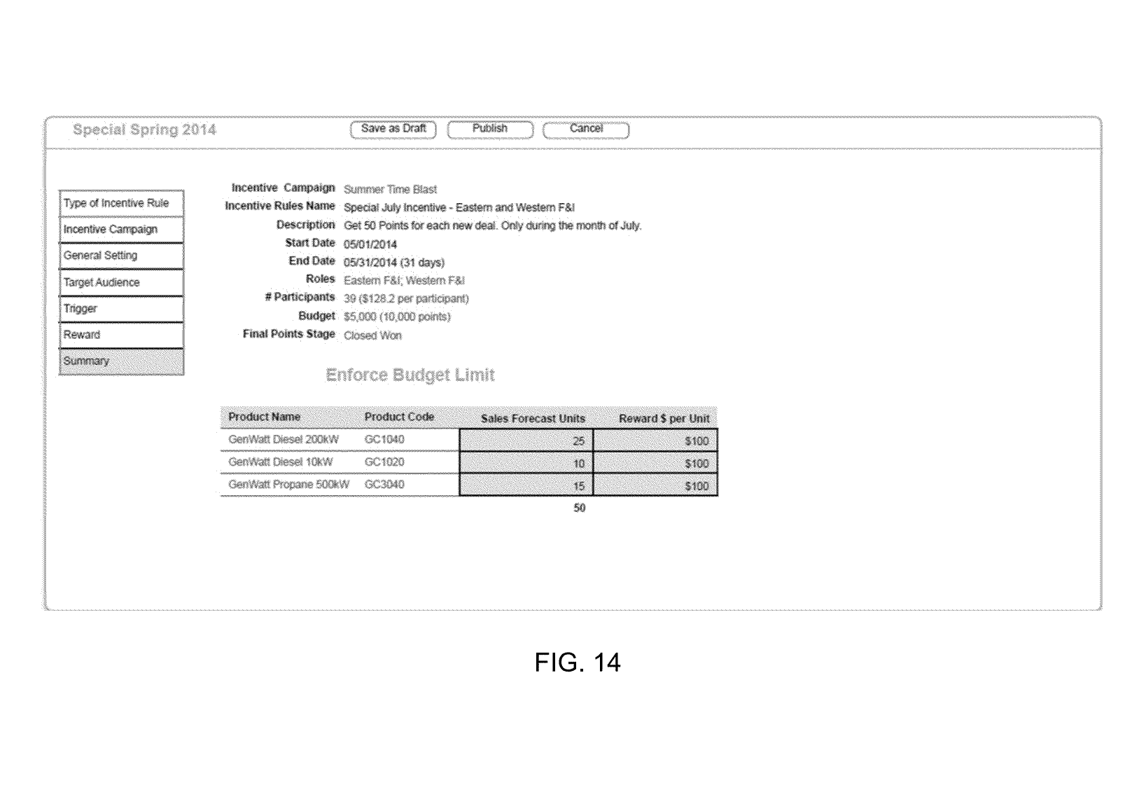

After specifying the criteria for the rule, the rule system 140 presents the authorized user of the business 130 with a summary interface 140 describing the rule. An example summary interface is shown in FIG. 14 and describes the information provided to the rule system 140 via the interfaces described in conjunction with FIGS. 2-13. Additionally, the summary interface presents an interface element allowing the authorized user to store the rule to the rule system 140. In some embodiments, the authorized user may request that the rule system 140 request confirmation from the authorized user before storing the rule, FIG. 12 shows an example interface allowing an authorized user to provide confirmation before the rule store 140 stores the rule.

### Virtual Hierarchy

In addition to allowing an authorized user of a business 130 to generate a rule based on additional rules maintained by the rule system 140, the rule system allows the authorized user to generate “virtual hierarchies” of users to whom a rule applies. For example, based on employees identified as subject to a rule, the rule system 140 generates a hierarchy of the identified employees and stores information identifying the identified employees in association with the rule. This allows an authorized user to more easily identify employees of a business 130 subject to the rule or to retrieve the employees' performance relative to the rule. As some rules may apply to employees in disparate locations of an organizational structure of a business, storing information identifying users subject to a rule simplifies subsequent evaluation of users based on the rule. Information associated with the users subject to the rule may also be used to indicate relationships (e.g., hierarchical relationships) between various users subject to the rule.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

What is claimed is:

1. A method comprising:
maintaining information describing rules for providing employees with benefits based on satisfying performance metric criteria, each rule identifying a benefit and one or more performance metric criteria;
maintaining information associated with at least a set of the rules describing one or more prior implementations of a rule by one or more businesses;
obtaining information associated with a business;
selecting one or more rules from the maintained information based on the obtained information associated with the business and the maintained information associated with at least the set of the rules;
identifying the selected one or more rules to an authorized user associated with the business;
receiving a selection of a rule from the selected one or more rules;
receiving authorization from the authorized user associated with the business to access at least a subset of information maintained by the business and associated with employees of the business;
determining that an employee of the business satisfies one or more performance metric criteria included in the selected rule based on information associated with the employee in the subset of information maintained by the business; and
communicating information describing a benefit included in the selected rule to the business in response to the determining.

2. The method of claim 1, wherein information associated with the rule describing the one or more prior implementations of the rule by one or more businesses comprises a number of times the one or more businesses have implemented the rule.

3. The method of claim 2, wherein selecting one or more rules from the maintained information based on the obtained information associated with the business and the maintained information associated with at least the set of the rules comprises:
selecting one or more rules that have been implemented at least a threshold number of times.

4. The method of claim 1, wherein the obtained information associated with the business comprises an industry associated with the business.

5. The method of claim 4, wherein selecting one or more rules from the maintained information based on the obtained information associated with the business and the maintained information associated with at least the set of the rules comprises:
selecting one or more rules that have been have been implemented by at least a threshold number of additional businesses associated with the industry.

6. The method of claim 1, wherein information associated with the rule describing the one or more prior implementations of the rule by one or more businesses comprises an amount of compensation provided by one or more additional businesses to employees from implementation of the rule.

7. The method of claim 1, wherein selecting one or more rules from the maintained information based on the obtained information associated with the business and the maintained information associated with at least the set of the rules comprises:
selecting one or more rules based on amounts of compensation provided by one or more additional businesses to employees based on implementation of the rule and budget information included in the obtained information associated with the business.

8. The method of claim 1, wherein the one or more of the rules were created by an additional business different from the business.

9. The method of claim 1, wherein information associated with the rule describing the one or more prior implementations of the rule by one or more businesses comprises one or more selected from a group consisting of: ratings received form the one or more businesses, comments received from the one or more businesses, a description of operation of the rule, information describing strengths and weaknesses of the rule, information identifying alternative rules associated with the rule, and any combination thereof.

10. A method comprising:
maintaining information describing rules for providing employees with benefits based on satisfying performance metric criteria, each rule identifying a benefit and one or more performance metric criteria;
maintaining information associated with at least a set of the rules describing one or more prior implementations of a rule by one or more businesses;
obtaining information associated with a business;
selecting one or more rules from the maintained information based on the obtained information associated with the business and the maintained information associated with at least the set of the rules; and
identifying the selected one or more rules to an authorized user associated with the business.

11. The method of claim 10, wherein information associated with the rule describing the one or more prior implementations of the rule by one or more businesses comprises a number of times the one or more businesses have implemented the rule.

12. The method of claim 11, wherein selecting one or more rules from the maintained information based on the obtained information associated with the business and the maintained information associated with at least the set of the rules comprises:
selecting one or more rules that have been implemented at least a threshold number of times.

13. The method of claim 10, wherein the obtained information associated with the business comprises an industry associated with the business.

14. The method of claim 13, wherein selecting one or more rules from the maintained information based on the obtained information associated with the business and the maintained information associated with at least the set of the rules comprises:
selecting one or more rules that have been have been implemented by at least a threshold number of additional businesses associated with the industry.

15. The method of claim 10, wherein information associated with the rule describing the one or more prior implementations of the rule by one or more businesses comprises an amount of compensation provided by one or more additional businesses to employees from implementation of the rule.

16. The method of claim 10, wherein selecting one or more rules from the maintained information based on the obtained information associated with the business and the maintained information associated with at least the set of the rules comprises:
selecting one or more rules based on amounts of compensation provided by one or more additional businesses to employees based on implementation of the rule and budget information included in the obtained information associated with the business.

17. The method of claim 10, wherein the one or more of the rules were created by an additional business different from the business.

18. The method of claim 10, wherein information associated with the rule describing the one or more prior implementations of the rule by one or more businesses comprises one or more selected from a group consisting of: ratings received form the one or more businesses, comments received from the one or more businesses, a description of operation of the rule, information describing strengths and weaknesses of the rule, information identifying alternative rules associated with the rule, and any combination thereof.
